(19) United States
(12) Patent Application Publication
(10) Pub. No.: US 2026/0230780 A1
(43) Pub. Date: Aug. 6, 2026

(54) FUSING OF SENSOR DATA OF A VEHICLE WITH SENSOR DATA OF A TELECOMMUNICATIONS DEVICE

(71) Applicant: Valtech Mobility GmbH, München (DE)

(72) Inventor: Stefan Rohe, Sömmerda (DE)

(73) Assignee: Valtech Mobility GmbH, München (DE)

(21) Appl. No.: 19/151,984

(22) PCT Filed: Jan. 30, 2024
(86) PCT No.: PCT/EP2024/052164

§ 371 Date: Jul. 29, 2025

(30) Foreign Application Priority Data
Jan. 30, 2023 (DE) 10 2023 102 158.3

(51) Int. Cl. H04W 4/38; G07C 5/00; G07C 5/08; H04W 4/02; H04W 4/40

(52) U.S. Cl. CPC H04W 4/38; G07C 5/008; G07C 5/0808; H04W 4/025; H04W 4/40

(57) ABSTRACT

A method for determining a data set by means of a telecommunications device is provided, wherein the data set represents a use of a predetermined vehicle. A communication connection is established between the telecommunications device and the vehicle. If the telecommunications device detects a movement pattern that corresponds to a vehicle movement, it retrieves status reports from the vehicle. At least one comparison value is formed from parameter values of the status reports and parameter values of the telecommunications device. If the comparison value satisfies a predetermined criterion, it can be assumed that the telecommunications device is actually located in the vehicle to which it has connected. Data of the vehicle can now be fused with data of the telecommunications device.

### CROSS-REFERENCE TO RELATED APPLICATIONS

This application is a national phase entry of International Application No. PCT/EP 2024/052164, filed Jan. 30, 2024, which claims priority to German Patent Application Serial No. DE 10 2023 102 158.3, filed Jan. 30, 2023, the entire disclosures of which are hereby incorporated herein by reference in their entirety.

### FIELD OF THE INVENTION

The invention relates to a method for determining a data set in a telecommunications device, wherein the data set describes a use of a predetermined vehicle.

### BACKGROUND OF THE INVENTION

Vehicles that have sensors for acquiring usage data and transmitting these data to a server via a mobile radiotelephone connection are known in the prior art. Vehicles of this type are also referred to as “connected.” However, the cell phone connection is usually reserved for the vehicle manufacturer. It is also usually a proprietary server that cannot be accessed by the user and/or third parties.

In the course of marketing the data recorded by the vehicle, third parties are granted access to these data, albeit to a greatly reduced extent. However, on the basis of this extent it is not possible to realize and offer products adequate for assisting during the use of the vehicle, in particular because in many cases it is not clear who the driver is.

FIGS. 1A-1C show a schematic overview of various previously known architectures of applications for assisting during the use of a connected vehicle.

FIG. 1A shows the architecture of a manufacturer's own approach to a solution for a connected vehicle. The connected vehicle transmits usage data to a manufacturer's server, where applications related to the vehicle are generated from the transmitted data.

The data recorded and provided by the connected vehicle lack an adequate data quality since data from certain sensors are simply not available or the data provided are generally not of the required resolution or frequency.

Limits in data quality and quantity also arise from the fact that the bandwidth of the connected vehicle is very limited. This means that the data required for data-driven third-party applications could not be transmitted from the vehicle via cell phone in the required quantity and quality, even if these data were available from the manufacturer.

In addition, users of connected vehicles have so far had no way of consenting to the use of data collected during vehicle use by third parties in the vehicle, i.e. of authorizing the use of the data before it is collected.

Due to these disadvantages, data-driven application cases for assisting during the use of a connected vehicle, which application cases are provided by third parties, can be implemented technically only inadequately.

As shown in FIG. 1B, there are solutions in the prior art that rely on data from the cell phone carried on board instead of data from the connected vehicle. However, to reliably detect whether the cell phone is being carried, additional hardware is required that is permanently installed in the vehicle. This increases the cost of the application provided by third parties. In addition, due to the additional hardware, the installation of the application is laborious for the user compared to the usual process of setting up a new application on the cell phone. This reduces the user acceptance of these approaches to a solution. Data provided by the vehicle itself are not taken into account or are not collected.

In a variant shown in FIG. 1C, the cell phone data are used for a data-driven application for assisting during the use of a vehicle, but potentially at any time, i.e. even without the vehicle actually being used.

Not even in the variants according to FIGS. 1B and 1C, can the user consent to the use of the data.

In all three variants, it is not possible to determine which user is actually using a vehicle.

### OBJECT OF THE INVENTION

An object of the present invention is therefore to at least partially reduce the aforementioned disadvantages of introducing a data-driven application provided by third parties for assisting during the use of a vehicle and to improve the quantity and quality of the data required for this purpose.

### SUMMARY OF THE INVENTION

The above object is achieved by the method according to claim 1. Advantageous embodiments of the method are given in the dependent claims.

Accordingly, a method is provided for determining a data set by means of a telecommunications device, wherein the data set represents a use of a predetermined vehicle, wherein the telecommunications device comprises a device for determining a geocode and an inertial sensor device, the method comprising the following steps:
a) establishing a communication connection between the telecommunications device and the predetermined vehicle,
b) detecting a movement pattern of the telecommunications device which is associated with a state of vehicle movement, the movement pattern being determined by evaluating measurement data from the inertial sensor device,
c) retrieving a predetermined number of status reports from the predetermined vehicle, each status report storing values for a number of physical parameters associated with the predetermined vehicle,
d) determining a comparison value based on the values of at least one physical parameter stored in the status reports and based on values for corresponding physical parameters provided by the telecommunications device, and
e) if the comparison value satisfies a predetermined criterion, determining the data set by fusing values from continuously retrieved status reports of the predetermined vehicle with a number of values for physical parameters provided by the telecommunications device.

The recognition of the movement pattern of the telecommunications device is carried out by the telecommunications device itself.

The retrieval of the predetermined number of status reports from the predetermined vehicle is carried out by the telecommunications device, i.e. at the request of the telecommunications device. The predetermined number of status reports can preferably be retrieved via the communication connection established in step a).

The comparison value is determined by the telecommunications device. If the comparison value meets a predetermined criterion, the telecommunications device is located in the vehicle.

In step e), determining the data set is carried out by the telecommunications device by fusion.

By “corresponding” physical parameters is meant that when determining a comparison value for a physical parameter from the status report, a parameter of the telecommunications device is used that technically matches the physical parameter from the status report. For example, an acceleration of the vehicle and an acceleration of the telecommunications device, or an interior temperature of the vehicle and an ambient temperature of the telecommunications device, can be used.

According to the invention, the aforementioned disadvantages are to be remedied by connecting the vehicle to the telecommunications device. Installation of an additional hardware component in the vehicle is not required.

The core of the invention is that the telecommunications device is connected to the predetermined vehicle in such a way that said device can retrieve and evaluate status reports (data) of the vehicle and from these can detect whether the telecommunications device is located in the vehicle. The latter is recognized by a comparison value determined between the evaluated status reports and the data collected by the telecommunications device (physical variables) exceeding a predetermined threshold value.

The advantage of this is that the data on vehicle use are collected for a specific purpose and specifically for the data-driven application. On the one hand, no data stream is established for the application if the predetermined vehicle is being moved without the telecommunications device in it. On the other hand, no movement data are collected from the telecommunications device for the application if the telecommunications device is moving with or in another vehicle. For this reason, unless it is recognized that the telecommunications device is actually located in the vehicle connected to it, no data collection will take place. It would be possible for the telecommunications device to be located in a first vehicle but connected to a second vehicle driving alongside it; in this case, the invention makes it possible to detect that the telecommunications device is not located in the second vehicle to which it is connected, and data collection does not take place. Only the data necessary to determine that the telecommunications device is actually located inside the vehicle are requested. Furthermore, it can be provided that data are collected only if the user explicitly consents to data collection (e.g. by means of a corresponding user input on the telecommunications device).

For example, geocodes can be used for this purpose. The geocodes of the telecommunications device are determined by a device provided for this purpose. This device can be a GPS receiver, in which case the geocodes are determined from satellite signals.

The GPS receiver can in particular be a receiver of the Global Navigation Satellite System (GNSS) and can receive and evaluate signals from various satellite systems, such as GPS, GALILEO, GLONASS, and/or BeiDou. The device can also include a WLAN receiver, in which case the geocodes can be determined by WLAN triangulation.

The geocodes include at least coordinates of the current position of the telecommunications device, e.g. in the form of a combination of longitude and latitude, and the current speed of the telecommunications device.

The invention provides that the retrieval of the status reports and determination of the comparison value only take place when a movement pattern of the telecommunications device has previously been detected that corresponds to a vehicle movement. In other words, it is checked whether the movement pattern of the telecommunications device matches a movement pattern of the predetermined vehicle. For this purpose, the movement of the telecommunications device is classified within a plurality of states, such as walking, sitting, cycling, playing golf, or driving the vehicle. This classification is carried out by evaluating the data provided by an inertial sensor device of the telecommunications device, which includes acceleration values and/or gyroscope values and/or inclination angle values. The advantage of this upstream check is that vehicle status reports do not have to be queried continuously, but only at specific times, namely when the telecommunications device is suspected to be within a (moving) vehicle.

Alternatively or additionally, it can be provided that the vehicle signals or reports an ignition process to the telecommunications device. In one embodiment of the invention, it can then be provided that the status reports are retrieved only when an ignition process has been signaled. It is to be noted that signaling the ignition process is only optional.

The inertial sensor device comprises at least one acceleration sensor. In addition, the inertial sensor device can comprise a gyroscope and/or an inclination sensor.

The wireless connection between the telecommunications device and the predetermined vehicle can be a cellular connection. The wireless connection can be end-to-end encrypted so that messages can be sent and received directly between the connected vehicle and the telecommunications device. Likewise, a server can be connected between the networked vehicle and the telecommunications device, via which server the messages are transmitted and, if necessary, stored for analysis purposes.

The fusion of the data collected by the connected vehicle (status reports) and the data from the telecommunications device has the advantage of overcoming the aforementioned problems regarding data quality and data quantity. Furthermore, the bandwidth of the telecommunications device is sufficiently dimensioned for the transmission of high-quality data.

While the status reports provide a maximum of one speed value per minute, the telecommunications device can usually provide speed values at a frequency of 1 Hz. The status reports contain virtually no information about the acceleration values recorded during a trip with the connected vehicle. The telecommunications device, on the other hand, can by means of the inertial sensor device provide acceleration values with a frequency of 100 Hz or higher. Conversely, the telecommunications device has no means of detecting other vehicle occupants or fuel consumption, which in turn may be included in the status reports of the connected vehicle and which are not subject to any high-frequency changes.

As a result of the fusion, a data set can thus be determined or enriched that provides significant added value for the use of the connected vehicle in a data-driven application of the telecommunications device.

Advantageously, the status reports are fused with the data of the telecommunications device in the application of the telecommunications device. In addition, the collected data is stored exclusively in a storage device of the telecommunications device. The advantage of this configuration is that the telecommunications device has complete control over the data stream in the application. Consequently, a user whose use of the predetermined vehicle is the subject of the collected data may consent to the data processing on the telecommunications device and to a possible forwarding of pre-aggregated data to third parties.

The method according to the invention can therefore be summarized as follows:
a) The telecommunications device connects to a vehicle.
b) The telecommunications device detects a movement pattern that corresponds to a vehicle movement, and it is therefore presumed that the telecommunications device is located in a moving vehicle. Steps a) and b) can also be carried out in reverse order.
c) After the telecommunications device has connected to the vehicle and the telecommunications device has detected the movement pattern mentioned (which does not yet ensure that the telecommunications device is actually located in the connected vehicle), the telecommunications device retrieves status reports with parameter values from the vehicle.
d) The retrieved parameter values are compared with parameter values provided by the telecommunications device and a comparison value is determined.
e) If the comparison value satisfies a predetermined criterion, it can be assumed that the telecommunications device is actually located in the vehicle, and data from the vehicle can now be fused with data from the telecommunications device in order to generate the data set.

It is advantageous if the telecommunications device for establishing the communication connection is authenticated, preferably by means of a QR code, and authorized, preferably by input of a shared secret.

Performing an authentication of the telecommunications device application on the connected vehicle enables the establishment of an encrypted direct connection between the application and the connected vehicle. The authorization of the application also enables the application to be authorized in the first place to request status reports or make further requests of the connected vehicle.

The method can optionally further comprise: transmitting the values from the status reports of the predetermined vehicle and the values for the physical parameters provided by the telecommunications device from the telecommunications device to a server by means of a data connection, wherein the data set can be determined on the server in step e).

The advantage of determining the data set by fusing the data collected and transferred to the server is that data processing requires less maintenance. When data is processed entirely within the telecommunications device, it is necessary to keep the application compatible with different operating systems of the manufacturers of telecommunications devices and their versions. In a fleet of several thousand telecommunications devices, the heterogeneous manufacturer landscape and the evolution of the operating systems of the telecommunications devices result in a considerable additional effort in data processing compared to processing all provided application data in one server.

Optionally, the data set, i.e. the data fused at the telecommunications device, can be transmitted from the telecommunications device to a server via a data connection. This has the advantage that only data relevant to the specific use case are transmitted. This aspect can already be taken into account in the fusing of the data.

The comparison value can be determined by calculating a correlation between values of a physical parameter from the status reports and values of a corresponding physical parameter provided by the telecommunications device, wherein the physical parameter and the corresponding physical parameter are selected from the group comprising:
current speed of the vehicle and a speed provided by the device for determining a geocode,
acceleration of the vehicle and acceleration of the telecommunications device,
angular acceleration of the vehicle and angular acceleration of the telecommunications device,
GPS position of the vehicle and GPS position of the telecommunications device,
steering angle of the vehicle and GPS position of the telecommunications device including map data,
interior temperature of the vehicle and ambient temperature of the telecommunications device,
brightness in the interior of the vehicle and ambient brightness of the telecommunications device,
noise in the interior of the vehicle and ambient noise of the telecommunications device,
charging data of the vehicle battery and charging data of the telecommunications device coupled to a wallbox or to a public charging device, and
combinations thereof.

The aforementioned parameters or parameter values can be recorded as time series. The comparison value can thus be determined for example by calculating a correlation between the time series of speeds from the status reports with the time series of speeds from the geocodes of the telecommunications device.

This determination is carried out for example by calculating a cross-correlation between two time series. This approach has the advantage that the comparison value is determined not only on the basis of a single data point but over a certain period of time. This allows the comparison value to indicate with great accuracy whether the telecommunications device is actually located inside the predetermined vehicle.

Each status report can include an odometer reading of the vehicle and the number of vehicle occupants, wherein from each status report the odometer reading, the number of vehicle occupants, the current speed and the location of the last position are fused with the number of geocodes, a number of acceleration values of the inertial sensor device and an indication of the use of the telecommunications device by correlating the number of geocodes with the speed and the location from the status reports, wherein the data set represents an evaluation of a driving style.

When determining the dataset by fusion, the dataset can be enriched with map data, whereby the enriched dataset includes criteria for evaluating the driving style which are selected from the group comprising: speeding,
strong acceleration values,
accident-like braking,
use of the telecommunications device while driving,
travel times,
disregard of traffic regulations,
driver fatigue,
weather conditions,
trip duration,
street type,
danger of distraction, and
combinations thereof.

This specialized application makes possible the processing of behavior-based motor vehicle insurance. The evaluation of the driving style can be carried out for each trip individually and for a specific driver (the driver to whom the telecommunications device is assigned) on the basis of a weighting of the evaluation criteria listed above, and averaged over time from different trips. By evaluating the vehicle's odometer reading, the actual number of kilometers traveled with the vehicle can also be taken into account when calculating an insurance premium. Another advantage of this application is that the recorded routes can be displayed for examination of the behavior shown in traffic. This can reduce the likelihood of accidents.

The measured values of the inertial sensor device can comprise acceleration values, the method further comprising:
f) monitoring acceleration values and reporting an extreme acceleration event the acceleration value of which exceeds a predetermined threshold value,
g) retrieving information about the extreme acceleration event from the predetermined vehicle, wherein the data set comprises the acceleration values and the number of geocodes from a predetermined time interval preceding the extreme acceleration event and the information about the extreme acceleration value.

This specialized application thus makes automated accident detection possible, within which damage that has occurred can also be automatically estimated. If the acceleration sensor of the inertial sensor device is precisely calibrated, the extreme acceleration event can be characterized from the high-resolution acceleration data, i.e. the severity of an impact and its direction of impact can be precisely estimated. A high resolution of the acceleration data is necessary precisely because due to the impact the initial acceleration pulse builds up and decays again within a few milliseconds. The automatic assessment of body damage can significantly speed up insurance claim processing. When an accident is detected, the telecommunications device can retrieve information about the context in the form of telemetry data and/or other data from the vehicle.

The method can further comprise querying a fuel level of the predetermined vehicle, and detecting a reduction in the fuel level when the predetermined vehicle is stationary, wherein the data set includes the location of the last position and values of the fuel level before and after the reduction.

A status report of the predetermined vehicle can additionally comprise a charge level of a battery of the predetermined vehicle, wherein the telecommunications device determines an ambient temperature at predetermined time intervals, wherein the data set comprises a fusion of the charge level of the battery, the ambient temperature, the odometer reading and the current speed with the number of geocodes, such that the data set represents an evaluation of the use of the battery.

This specialized application makes it possible to evaluate the use of the battery of the predetermined vehicle, in particular a (partially) electric vehicle.

In one embodiment of the invention, the telecommunications device can be a cell phone.

Likewise, the telecommunications device can be a tablet or a smartwatch.

In one embodiment of the invention, the communication connection may be a wireless communication connection.

### BRIEF DESCRIPTION OF THE DRAWINGS

Details and features of the invention as well as specific, particularly advantageous exemplary embodiments of the invention result from the following description in conjunction with the drawing. In the figures:

FIGS. 1A-1C show a schematic overview of various previously known architectures of applications for assisting during the use of a connected vehicle;

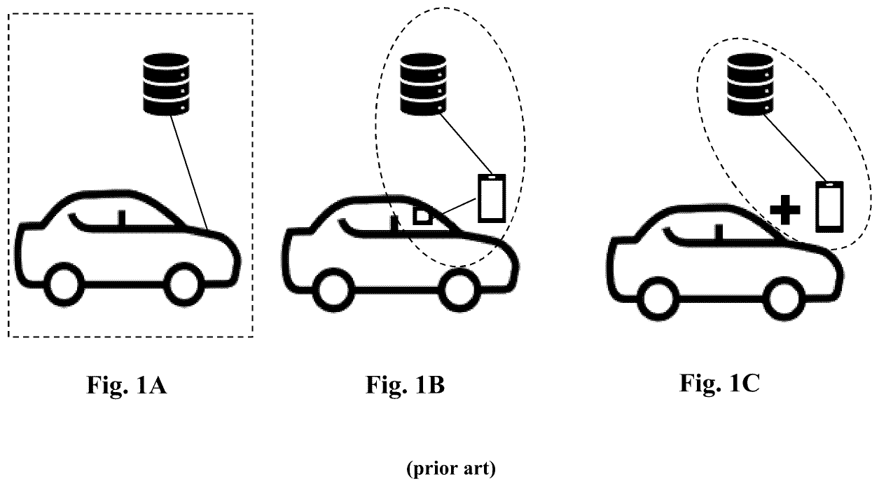

FIG. 2 is a schematic representation of the data streams in a data-driven application according to one aspect of the invention;

FIG. 3 is a flow diagram for an embodiment of the method according to the invention;

FIG. 4 is a diagram for determining a comparison value according to one aspect of the invention.

### DETAILED DESCRIPTION OF THE INVENTION

The core idea of the solution according to the invention is to easily determine from the data available from the networked vehicle and the telecommunications device whether the telecommunications device is moving with the vehicle, i.e. whether the telecommunications device is located in the vehicle. If this is the case, the data from both sources, i.e. from the vehicle and from the telecommunications device, can be fused in an application-specific manner. In this respect, the quality and quantity of data provided by the vehicle can be drastically improved and, at the same time, data collection using the telecommunications device can be designed in a data-saving manner, i.e. only related to the particular purpose of the application and only to the extent necessary for the evaluation.

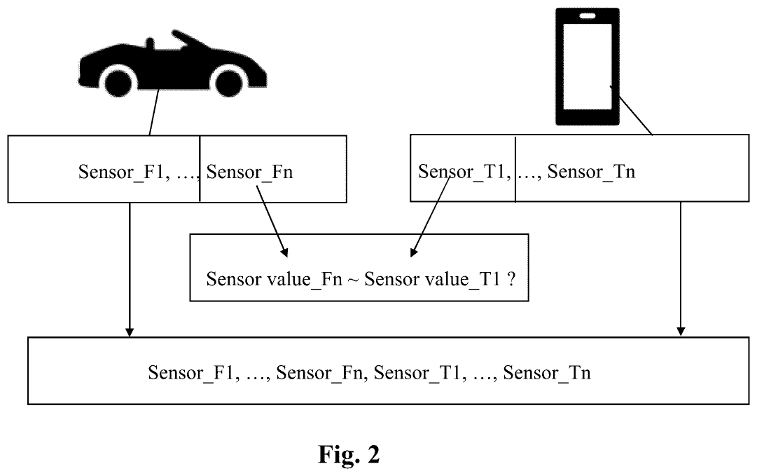

FIG. 2 shows a schematic representation of the data streams in a data-driven application according to one aspect of the invention.

The starting point of the solution according to the invention is that both the vehicle and the telecommunications devices each comprise a number of sensors, the values of which can be made available in an application of the telecommunications devices, for example by queries (“pull”) or as a message from the networked vehicle (“push”). For this purpose, a connection first has to be established between the telecommunications device and the vehicle.

In one embodiment of the method according to the invention, the application first determines the manufacturer of the vehicle. The background here is that the status reports provided by the vehicle are only partially specified, so that more or fewer data are provided by the connected vehicle depending on the manufacturer. According to one aspect of the invention, the corresponding vehicle manufacturer can be selected in the application from a list of manufacturers. After selection of the manufacturer, the application establishes an encrypted connection to the connected vehicle. To do this, the application must authenticate itself to the connected vehicle, for example using a QR code or other known mechanisms. Preferably, the application should also be vis-à-vis the connected vehicle. Once the encrypted connection has been successfully established, the keys used for this purpose can be stored in the application on the telecommunications device. In other words, the telecommunications device represents a security token by means of which the collection of data from the use of the vehicle can be easily approved or rejected.

By means of the keys of the predetermined vehicle stored in the application, status reports can be retrieved from the vehicle. These status reports include a series of values from the vehicle's sensors. For example, status reports can be queried once an hour while the vehicle is stationary. If the vehicle is moving, status reports can be queried once per minute. However, status reports often contain only sparse information, such as the coordinates of the vehicle's last parking position, fuel level, current speed, number of vehicle occupants, and odometer reading. In particular for insurance data products, the data in status reports are therefore inadequate both in scope and rate.

Once the telecommunications device and the vehicle are connected or paired via an encrypted connection over the internet, and the user has additionally approved the use of the data collected by the application (opt-in), the application first determines whether the telecommunications device is moving with the vehicle.

For this purpose, the movement of the telecommunications device is continuously classified into movement patterns. These movement patterns can be divided into the states of running, cycling, driving in a vehicle, walking, etc. The movement patterns can be detected by evaluating acceleration data from the inertial sensor device of the telecommunications device. This evaluation can, for example, include interval-based and/or frequency-based time series classifiers.

In one embodiment of the invention, the telecommunications device can determine the start of a trip via movement heuristics (using acceleration data of the inertial sensor device of the telecommunications device) without using position data (GPS, GNSS, . . . ).

In the same way, the telecommunications device can detect the end of a trip, i.e. by means of movement heuristics. By means of movement heuristics, it can also be detected whether a trip has actually been completed or whether the vehicle is only stationary, for example to refuel; this means that a plurality of trip sections between which the vehicle stops briefly can be considered as one trip, which can be relevant for example in insurance applications. Interruptions in the trip can thus be detected exclusively by the telecommunications device without the need for data from the vehicle status reports.

As soon as the start of a trip is detected, the telecommunications device can begin buffering the data (GPS, accelerations, . .. ).

The buffered data can be used in the determination of whether the telecommunications device is located in the vehicle.

If the movement pattern “driving in a vehicle” is detected, a subset of the sensor values or data from the status reports and a subset of the data determined by telecommunications device will be compared with each other. The status reports will preferably only be retrieved from the vehicle when the “driving in a vehicle” movement pattern is detected and the telecommunications device is connected to the vehicle via the communication connection.

By evaluating the requested status reports, the application can determine whether the vehicle is also moving and what its last parking position was. A comparison value could therefore be calculated from the inverse distance between the geocodes determined by the telecommunications devices and the last parking position of the vehicle. The closer the positions from the geocode and the last parking position of the vehicle are to each other, the higher will be the comparison value. If the comparison value exceeds a predetermined threshold, it will therefore be possible to assume that the telecommunications device has been brought into the predetermined vehicle and is now moving with it.

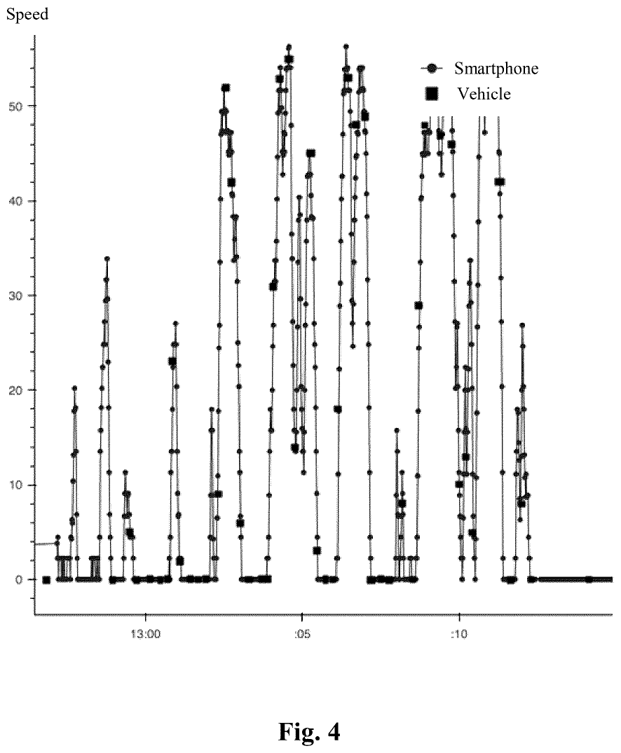

To improve the determination of comparison values in situations in which the vehicle was parked without GNSS reception, the comparison value can also be determined from the speeds recorded by the vehicle and by the telecommunications devices. This embodiment of the method according to the invention is explained in more detail with reference to FIG. 4.

If a match is found between the selected sensor values of the predetermined vehicle and the selected sensor values of the telecommunications device, it will be assumed that the telecommunications device is located in the predetermined vehicle. In this case, the vehicle data and the data from the telecommunications device can be recorded and processed jointly (i.e. the data from the telecommunications device and the vehicle data retrieved or requested by the telecommunications device are fused into a common data set). Otherwise, the data recorded up to then will be deleted. Depending on the specific use case to be enabled by the recorded and processed data, selected sensor values of the predetermined vehicle are fused with the data from the telecommunications device. This allows the application to provide data products with a high data quality and based on additional data such as the odometer reading or the number of vehicle occupants.

The choice of the predetermined threshold value may depend on the specific application or data product. A relatively high threshold value can be set for behavior-based insurance, since sensitive personal data such as the coordinates of a trip in relation to the recorded speeds and accelerations are processed. A lower threshold can be set for monitoring the fuel level, since the fuel level is not usually a sensitive personal data set.

If the determined comparison value falls below the predetermined threshold value or the geocodes of the telecommunications device do not sufficiently correlate with the values read from the status reports, it can be assumed that the telecommunications device is not located within the predetermined vehicle. In this case, the data collected to determine the comparison value will not be further processed but will be deleted.

By means of the fused data, a number of different data-driven use cases can be implemented and provided for assisting during the use of a connected vehicle.

According to one aspect of the invention, behavior-based motor vehicle insurance can be realized, for example. For this application case, sensor data with the best possible resolution are required. Positions, speeds, accelerations, headings, and usage data of the telecommunications device can be collected from the telecommunications device. The odometer reading, positions and speeds can be extracted in low temporal resolution from the connected vehicle's status reports. If the match between the predetermined vehicle and the telecommunications device is detected, the data from the two data sources will be fused by a correlation between the position data and the speed data being determined. To determine the correlation between the speed data from the predetermined vehicle and from the telecommunications device, reference is made to FIG. 4.

The fused data set forms the data basis for the application of behavior-based motor vehicle insurance (“pay-how-you-drive”). The method according to the invention ensures that the policyholder is monitored by means of their telecommunications devices, e.g. smartphone, only when driving the insured (predetermined) vehicle. Based on the fused data set, a driving style evaluation or score can be determined. Strong acceleration and/or braking maneuvers, speeding, risky cornering, and using a smartphone while driving can worsen the score. The odometer reading of the connected vehicle can be used to determine whether the vehicle was moved without data recording between the last recorded trip and the current trip. For example, it can for example be checked whether the odometer reading at the start of a current trip matches the last reported odometer reading of the previous trip. Another advantage for behavior-based insurance applications is the inclusion of data regarding the number of vehicle occupants, which can be used to estimate the driver's potential for distraction.

The fused data set can also form the data basis for an automated damage report in the event of an accident. In this application case, vehicle accidents are to be reliably detected and the associated insurance company is to be informed about the expected damage. This can speed up the processing of the claim because it can be known at an early stage which parts need to be repaired and what the costs would be. By determining the strength and direction of the impact, as well as information about how many passengers were in which seat in the insured vehicle, injuries to the vehicle occupants can also be estimated.

According to one aspect of the invention, the application on the telecommunications device monitors the recorded acceleration values of the inertial sensor device for extreme acceleration events during vehicle use. An extreme acceleration event can be recognized by the fact that the acceleration value along at least one axis of the inertial sensor device is more than 1 g. As soon as an extreme acceleration event has been registered, the telecommunications device can query the connected vehicle as to whether it has registered an accident and, if so, how severe it was assessed to be and whether an airbag was deployed. Furthermore, it is possible to query which part of the vehicle's bodywork has been damaged or deformed. For the extreme acceleration event, the acceleration values in high resolution in the period of the last 5 minutes before the extreme acceleration event are transmitted to the affected insurance company in an incident report together with a chain of at least three last-recorded positions, the estimated accident severity, and the number of vehicle occupants.

By enriching the data with static vehicle data such as the manufacturer, model, model year, color, engine, additional equipment and prices for spare parts in the policyholder's country, the repair costs can be estimated automatically. If a repair seems economically appropriate, the necessary spare parts can be pre-ordered and the repair shop can be informed. This significantly reduces the processing of the damage claim resulting from the extreme acceleration event.

According to a further aspect of the invention, the fused data set can be used to monitor the fuel level. Vehicles with large tanks are particularly vulnerable to fuel theft. This application case is therefore particularly aimed at connected trucks. To monitor the fuel level, it can be queried once per hour from the predetermined vehicle as long as it is not moving. The query frequency can be increased once it is dark, because fuel theft is most likely when it is dark. In addition, the query frequency can be increased if the vehicle is parked in a location where fuel theft has previously been reported or detected.

In a specific embodiment of this use case, a message can be displayed to the user in his or her smartphone application if a drop in the fuel level has been detected while the predetermined vehicle was parked. If the smartphone is in the vehicle, the location of the smartphone can be used for reporting fuel theft. If the smartphone is not in the vehicle, the last parking position of the vehicle can be used for the fuel theft report. This report can be sent not only to the insurance company but also to the police. In addition, an anonymized report, which only includes the time, location and extent of the fuel theft, can be made available via a server to other users of the application.

According to another aspect of the invention, the fused data set can be used to monitor the usage of the battery of the connected vehicle. Batteries for electric vehicles have so far been expensive. By fusing vehicle data such as temperature, state of charge, odometer reading and speed with the positions and speeds of telecommunications devices, the use of the battery can be characterized and evaluated. This allows the condition of the battery to be estimated cost-effectively and efficiently, in particular during operation.

According to the invention, it is therefore provided that a fused data set is generated from the data of the vehicle and the data of the telecommunications device, wherein the fused data set is only generated if it has first been positively validated that the telecommunications device is located in the vehicle.

What the fused data set actually looks like, i.e. what information it contains, also depends on the specific application. Data that is not relevant for a specific application is not stored in the fused data set. Furthermore, it is provided that data from the vehicle and/or the telecommunications device that are not required for a specific application will not be collected or queried; i.e. only those data from the vehicle and/or the telecommunications device that are necessary for generating a fused data set for a specific application are collected or queried.

According to the invention, it is also provided that the correlation between the vehicle and the telecommunications device takes place entirely in or through the telecommunications device. For this purpose, neither vehicle data as such nor data from the telecommunications device as such are transmitted to a third party (e.g. a server). Only fused data records are transferred to a third party (e.g. an insurance company server), and only if it has previously been positively validated that the telecommunications device is located in the vehicle.

As explained above, the start and end of a trip are determined exclusively by the telecommunications device. The mentioned correlation between the vehicle and the telecommunications device takes place during the trip and not only at the end of the trip, the correlation being carried out exclusively in the telecommunications device. It can be advantageous if the telecommunications device independently selects times at which it queries vehicle data for the purpose of correlation; for example, the telecommunications device can retrieve vehicle data at certain acceleration values of the telecommunications device.

What is essential in the present invention is that the telecommunications device itself determines whether it is “riding in a vehicle.” For this purpose, vehicle data are used only to check whether the telecommunications device and the vehicle are moving congruently. In the present invention, the determination of whether a vehicle is moving is therefore not carried out on the basis of the vehicle data but exclusively on the basis of the data from the telecommunications device.

In the event that two telecommunications devices detect a trip in the same vehicle, it can be provided according to the invention to output a message to the two telecommunications devices which queries which user is driving. The user who is driving can confirm the query on his telecommunications device positively; alternatively, the user who is not driving can confirm the query on his telecommunications device negatively.

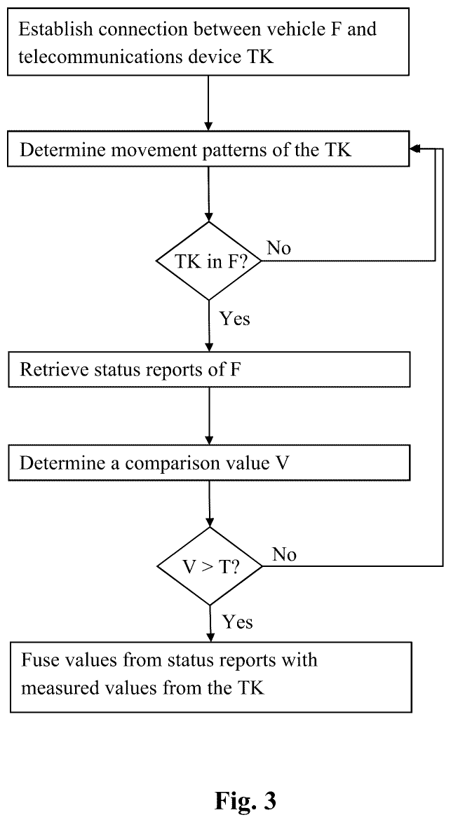

FIG. 3 shows a flow diagram according to an embodiment of the method according to the invention.

As explained above, according to the invention a connection is first established between the predetermined vehicle and the telecommunications device.

Next, movement patterns of the communication device are continuously determined. If a movement pattern of the telecommunications device detects that it is located in a vehicle (e.g. by matching a corresponding movement pattern of the vehicle), status reports of the predetermined vehicle are queried using the keys stored in the application. Otherwise, further movement patterns of the telecommunications device are classified.

The retrieved status reports of the predetermined vehicle are evaluated, i.e. the last parking position and/or the current speed are extracted from the status reports (according to the invention, other data can also be extracted from the status reports). Likewise, the geocode device of the telecommunications device continuously provides geocodes or locations. If reception is strong enough, the determined geocodes will include at least a pair of coordinates consisting of longitude and latitude, a speed, an orientation (“heading”), and a time stamp.

In the next step, the data evaluated from the vehicle reports and the geocodes of the telecommunications device are combined in a comparative value calculation. The comparison value can be calculated as a distance value based on the recorded positions and/or as a (cross-)correlation between the time series of the recorded speeds.

If the comparison value V exceeds a predetermined threshold value T or satisfies a predetermined condition/predetermined criterion, the sensor data retrieved from the vehicle will be fused with the geocodes and measurement data collected by the telecommunications device. The fused data set represents a use of a predetermined vehicle.

FIG. 4 shows a diagram for determining a comparison value according to one aspect of the invention.

The comparison shown in FIG. 4 is based on the speed values that were evaluated on the one hand from the vehicle status reports and on the other hand were determined by a device of the telecommunications device, in this case a smartphone.

To determine the comparison value, a predetermined number of status reports can be queried from the vehicle at a predetermined time interval and evaluated according to their speed indications. For example, ten status reports can be requested during the first 30 minutes of a trip. In this example, vehicle status reports were continuously retrieved and evaluated.

A first time series can be created from the speed values of the geocodes, and a second time series can be created from the speed values of the status reports.

The round data points on the first curve in FIG. 4 represent the first time series resulting from a high-frequency speed measurement of the smartphone during a trip. The square points on the second curve in FIG. 4 correspondingly represent the second time series. Visually, there is a perfect match between the first time series and the second time series. Although the two time series have different sampling rates and offset time stamps, the two time series fit together seamlessly when superimposed.

Furthermore, the comparison of the two time series can be quantified by a correlation analysis. For this purpose, a cross-correlation between the two time series can be calculated. The cross-correlation is normalized, resulting in a value of 1 for two identical time series, a value of 0 for two completely uncorrelated time series, and a value of −1 for two time series opposite in phase. In this case, the result of the cross-correlation is thus the comparison value, wherein the comparison value becomes more meaningful the longer the predetermined time interval or the larger the number of status reports queried.

We claim:

1. A method for determining a data set by means of a telecommunications device, wherein the data set represents a use of a predetermined vehicle, wherein the telecommunications device comprises a device for determining a geocode and an inertial sensor device, the method comprising the following steps:
a) establishing a communication connection between the telecommunications device and the predetermined vehicle,
b) detecting a movement pattern of the telecommunications device which is associated with a state of a vehicle movement, the movement pattern being determined by evaluating measurement data from the inertial sensor device,
c) retrieving a predetermined number of status reports from the predetermined vehicle, each status report storing values for a number of physical parameters associated with the predetermined vehicle,
d) determining a comparison value based on the values of at least one physical parameter stored in the status reports and based on values for corresponding physical parameters provided by the telecommunications device, and
e) if the comparison value satisfies a predetermined criterion, determining the data set by fusing values from continuously retrieved status reports of the predetermined vehicle with a number of values for physical parameters provided by the telecommunications device.

2. The method according to claim 1, wherein steps b), c), d) and e) are each carried out by the telecommunications device.

3. The method according to claim 1, wherein the telecommunications device for establishing the communication connection is authenticated, preferably by means of a QR code, and authorized, preferably by means of an input of a shared secret.

4. The method according to claim 1, further comprising transmitting the values from the status reports of the predetermined vehicle and the values for the physical parameters provided by the telecommunications device from the telecommunications device to a server by means of a data connection, wherein the data set is determined on the server in step e).

5. The method according to claim 1, further comprising transmitting the data set from the telecommunications device to a server by means of a data connection.

6. The method according to claim 1, wherein the comparison value is determined by calculating a correlation between values of a physical parameter from the status reports and values of a corresponding physical parameter provided by the telecommunications device, wherein the physical parameter and the corresponding physical parameter are selected from a group consisting of:
current speed of the vehicle and a speed provided by the device for determining a geocode,
acceleration of the vehicle and acceleration of the telecommunications device,
angular acceleration of the vehicle and angular acceleration of the telecommunications device,
GPS position of the vehicle and GPS position of the telecommunications device,
steering angle of the vehicle and GPS position of the telecommunications device including map data,
interior temperature of the vehicle and ambient temperature of the telecommunications device,
brightness in the interior of the vehicle and ambient brightness of the telecommunications device,
noise in the interior of the vehicle and ambient noise of the telecommunications device, and
charging data of the vehicle battery and charging data of the telecommunications device coupled to a wallbox or to a public charging device.

7. The method according to claim 1, wherein each status report includes an odometer reading of the vehicle and a number of occupants of the vehicle, wherein from each status report the odometer reading, the number of vehicle occupants, a current speed of the vehicle and a location of the vehicle's last position are fused with a number of geocodes from the device for determining a geocode, a number of acceleration values from the inertial sensor device and an indication of a use of the telecommunications device by correlating the number of geocodes with the speed and the location from the status reports, wherein the data set represents an evaluation of a driving style of a driver of the vehicle.

8. The method according to claim 1, wherein in determination of the data set by fusion, the data set is enriched with map data, wherein the enriched data set comprises criteria for evaluating a driving style of the driver of the vehicle, which are selected from a group consisting of:
speeding,
strong acceleration values,
accident-like braking,
use of the telecommunications device while driving,
travel times,
disregard of traffic regulations,
driver fatigue,
weather conditions,
trip duration,
street type, and
danger of distraction.

9. The method according to claim 1, wherein the measurement data of the inertial sensor device comprise acceleration values, the method further comprising:
f) monitoring acceleration values and reporting an extreme acceleration event in response to determining that an acceleration value associated with the event exceeds a predetermined threshold value,
g) retrieving information about the extreme acceleration event from the predetermined vehicle, wherein the data set comprises the acceleration values and a number of geocodes from the device for determining a geocode, wherein the acceleration values and number of geocodes are from a predetermined time interval preceding the extreme acceleration event and the receipt of information about the extreme acceleration value.

10. The method according to claim 1, further comprising querying a fuel level of the predetermined vehicle, and, when the predetermined vehicle is stationary, detecting a reduction in the fuel level, wherein the data set includes a location of a last position of the vehicle and values of the fuel level before and after the reduction in the fuel level.

11. The method according to claim 7, wherein each status report of the predetermined vehicle additionally comprises a charge level of a battery of the predetermined vehicle, wherein the telecommunications device ascertains an ambient temperature at predetermined time intervals, wherein the data set comprises a fusion of the charge level of the battery, the ambient temperature, the odometer reading and the current speed with the number of geocodes, such that the data set represents an evaluation of a use of the vehicle's battery.

12. The method according to claim 1, wherein a start and an end of a trip of the vehicle are recognized by the telecommunications device by means of movement heuristics of the telecommunications device.

13. The method according to claim 1, wherein steps c) and d) are carried out exclusively by the telecommunications device.

14. The method according to claim 1, wherein the telecommunications device is a cell phone.

15. The method according to claim 1, wherein the communications device is a wireless communications device.

16. The method according to claim 6, wherein the physical parameter and the corresponding physical parameter comprise the acceleration of the vehicle and the acceleration of the telecommunications device.

17. The method according to claim 6, wherein the physical parameter and the corresponding physical parameter comprise the angular acceleration of the vehicle and the angular acceleration of the telecommunications device.

18. The method according to claim 6, wherein the physical parameter and the corresponding physical parameter comprise the noise in the interior of the vehicle and the ambient noise of the telecommunications device.

19. The method according to claim 6, wherein the physical parameter and the corresponding physical parameter comprise the GPS position of the vehicle and the GPS position of the telecommunications device.

20. The method according to claim 6, wherein the physical parameter and the corresponding physical parameter comprise the interior temperature of the vehicle and the ambient temperature of the telecommunications device.
